(19) United States
(12) Patent Application Publication
(10) Pub. No.: US 2010/0006638 A1
(43) Pub. Date: Jan. 14, 2010

(54) PHOTOGRAPHY SYSTEM AND METHOD

(76) Inventors: Mark Bakic, Argyle, TX (US); Dawn Bakic, Argyle, TX (US)

Correspondence Address: DeLeon Law Group PC, 100 Crescent Court, Suite 700, Dallas, TX, 75201, US

(21) Appl. No.: 12/500,918

(22) Filed: Jul. 10, 2009

Related U.S. Application Data
(60) Provisional application No. 61/079,474, filed on Jul. 10, 2008.

(51) Int. Cl. G06F 17/00; B65D 27/00

(52) U.S. Cl. 235/375; 229/92.1

(57) ABSTRACT

The present disclosure provides for a two-sided, separable photography form for printing a prefatory photograph thereto and for subsequently retaining a prefatory photograph therefrom, the form having an upper portion; a middle portion; and a lower portion, the lower portion comprising an envelope. Additionally, the present disclosure provides for a photography method including capturing a prefatory photograph with a capture device; manipulating a digital representation of the prefatory photograph; manipulating a digital representation of an ordering information template; manipulating a digital representation of at least one identification code; manipulating postage payment information; and printing at least one prefatory photograph, at least one ordering instruction template, at least one identification code, and postage payment information to a two-sided, separable photography form.

### CROSS-REFERENCE TO RELATED APPLICATIONS

Applicants claim priority to U.S. Provisional Patent Application No. 61/079,474, filed Jul. 10, 2008, the disclosure of which is incorporated by reference herein in its entirety.

### DESCRIPTION OF THE DRAWINGS

FIG. 1 is a schematic diagram of a front side of a photography form comprising an embodiment of the present invention;

FIG. 2 is a schematic diagram of a back side of the photography form of FIG. 1;

FIG. 3 is a flow diagram comprising an embodiment of the present invention; and

FIG. 4 is a schematic diagram of FIG. 1 wherein prefatory photographs are printed thereon.

### DETAILED DESCRIPTION

A photograph is an image created by light falling on a light-sensitive surface, usually involving photographic film or an electronic imager such as a charge-couple device or a complementary metal-oxide-semiconductor. A photograph captures a specific image at a certain moment in time, thereby allowing individuals who view the photograph to reminisce of what once was. Yearly photographs of children, teenagers, and young adults attending school usually are created to capture various stages of maturity and to engender memories of that specific time period.

The current school photography process, however, can be inefficient and wrought with problems. Most school photo companies engage process protocol for digital photography as if it is film, negative and print. After a student's image is captured by a photographer during a photo shoot, a prefatory photograph is attached to ordering instructions and is either given to the student after the photo shoot or mailed to the student, school, and/or the student's guardian days or weeks after the photo shoot.

Once the student receives the prefatory photograph and ordering instructions, the student, especially a young student, may be prone to losing it, thus preventing the student and/or the student's guardian from viewing the prefatory photograph to determine if ordering the photograph(s) is desirable. As such, the student and/or the student's guardian would have to request an additional prefatory photograph and ordering instruction form. This process is time consuming and fraught with errors by nature.

If the student, however, does not lose the prefatory photograph and ordering instructions but correctly mailed both items to the photographer to order photograph(s), the student and/or the student's guardian, under current photography practices, would be unable to retain possession of the prefatory photograph for continued viewing or of the ordering instructions for additional future photograph orders. Current practices dictate that the prefatory photograph and the ordering instructions be placed into an envelope and mailed to the photographer's place of business or home address if inaccurate. Pictures may never be delivered to client, thereby divesting the student and/or the student's guardian of same.

Embodiments of the present invention provide a seamless and efficient system and process for capturing a student's image as a prefatory photograph to be affixed to a unique photography form wherein the photography form includes several portions, thereby affording the student and/or the student's guardian with an easy and efficient ordering process. Embodiments of the present invention not only include the system and method of printing the prefatory photograph to the photography form during photo shoots but also the system and method of creating the photography form.

The embodiments of the present invention provide a more efficient use of time during photo shoots since a student receives a form comprising the prefatory photographs and ordering instructions within moments of the photo shoot. Additionally, a student receives a form comprising three distinct, separable portions. Each portion functionally provides the student and/or student's guardian with the requisite components to effectively order the photograph(s) while allowing the student and/or student's guardian to retain possession of the prefatory photograph and ordering instructions after the order has already been placed.

To increase efficiency, each separable portion of the form has a unique identifiable code such as without limitation a bar code that is printed onto the form concurrently with the prefatory photograph at a photo shoot and that can be read and processed at a later time by a technician, computer scanner, or other similar device at a photography company. Therefore when the photography company receives the order, it can easily match the order to the photograph and customer.

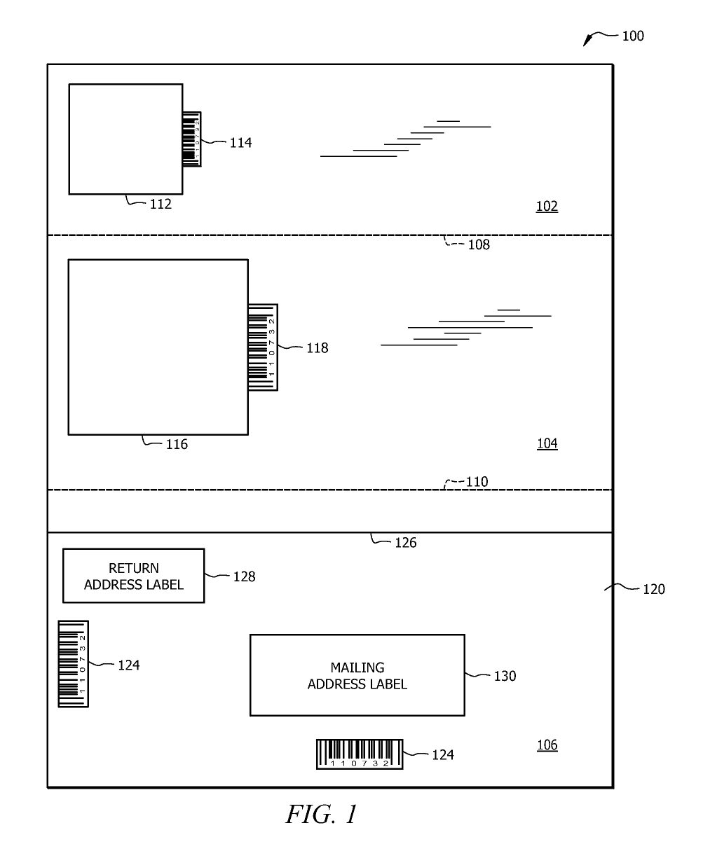

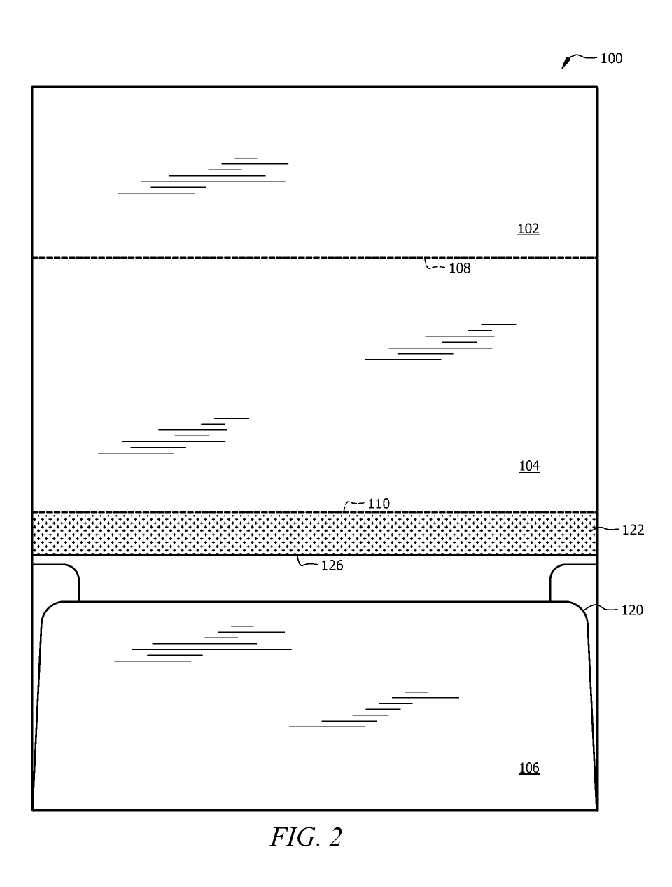

As depicted in FIGS. 1 and 2, a two-sided form 100 having a front side as shown in FIG. 1 and a back side as shown in FIG. 2 comprises an upper portion 102, middle portion 104, and lower portion 106. Between the upper portion 102 and middle portion 104 and the middle portion 104 and lower portion 106 are perforated lines 108, 110 respectively. The perforated lines 108, 110 allow the separation of each portion from adjacent portions of form 100 such as by tearing.

Turning to FIG. 1, the upper portion 102 of the front side of form 100 comprises an prefatory photograph area 112 wherein a prefatory photograph is captured and printed to the prefatory photograph area 112 at a photo shoot. Adjacent to the prefatory photograph area 112 is a unique identification code 114 such as but not limited to a bar code readable by a computer scanner or other such computer device that interacts with such computer device and/or software application for tracking and identification purposes. Additionally, upper portion 102 of form 100 comprises ordering instructions and information regarding payment of fees for the ordering of photograph(s). The student and/or the student's guardian supplies the upper portion 102 with personal information such as an a name, address, credit card number and/or bank account number along with ordering information such as the number and/or size of photographs requested.

The middle portion 104 of the front side of form 100 comprises a prefatory photograph area 116 wherein a prefatory photograph is captured and printed to the prefatory photograph area 116 at a photo shoot. Adjacent to the prefatory photograph area 116 is a unique identification code 118 such as but not limited to a bar code readable by a computer scanner or other such computer device that interacts with such computer device and/or software application for tracking and identification purposes. Additionally, middle portion 104 of form 100 comprises ordering instructions, information regarding payment of fees for the photograph(s), and other advertising information.

The student and/or the student's guardian retain the middle portion 104 of form 100 for price referencing, record-keeping, and viewing of the prefatory photograph while the ordered photograph(s) are prepared by the photography company. Utilizing the middle portion 104, the student and/or the student's guardian has the requisite information to procure additional photograph orders. Also, the photography company can utilize the middle portion 104 as an advertising medium, including information concerning products and/or services which might be of interest to the student, student's guardian or others.

A person of ordinary skill in the art will appreciate the interchangeability of the upper portion 102 and middle portion 104 of form 100. While an embodiment expressly disclosed herein provides for the separation of the upper portion 102 and insertion thereof into envelope 120 of lower portion 106, other embodiments envision the separation of the middle portion 104, insertion thereof into envelope 120 of lower portion 106, and retention of the upper portion 102 by the student or student's guardian.

The lower portion 106 of form 100 comprises the front side of envelope 120 and creased line 126 formed when the lower portion 106 is detached and the flap of envelope 120 having an adhesive section 122 as shown in FIG. 2 is folded to seal the contents of envelope 120 therein. The front side of envelope 120 also comprises a return address label 128 provided by the student and/or the student's guardian and a mailing address label 130 indicating the photographer's business address. A person of ordinary skill in the art will appreciate that lower portion 106 can be attached to form 100 in either one of two ways, to wit: the front side of envelope 120 can be positioned at and attached to the front side of form 100 as depicted in FIG. 1, or in the alternative, the front side of envelope 120 can be positioned at and attached to the back side of form 100.

Additionally, lower portion 106 comprises one or more unique identification codes 124 positioned at various locations thereon. The unique identification code(s) 124 such as but not limited to a bar code is readable by a computer scanner or other such computer device and interacts with such computer device and/or a software application for tracking and identification purposes.

Envelope 120 of lower portion 106 of form 100 may utilize the United States Postal Service's Centralized Account Payment System for postal payment. The Centralized Account Payment System is an electronic system available to business mailers for all classes of mail and provides business mailers the ability to pay for postage electronically through one central location regardless of the number or location of postal permits obtained or the class of mail used. As such, envelope 120 may comprises information displayed thereon relating to the Centralized Account Payment System.

Turning to FIG. 2, the back portion of form 100 is shown. Similar to FIG. 1, FIG. 2 comprises the upper portion 102, middle portion 104, and lower portion 106 of form 100. Between the upper portion 102 and middle portion 104 and the middle portion 104 and lower portion 106 are perforated lines 108, 110 respectively. The perforated lines 108, 110 allow for the separation of each portion from adjacent portions of form 100 such as by tearing.

As depicted in FIG. 2, the back side of upper portion 102 and of middle portion 104 of form 100 can be used for advertisement, promotional, or information purposes. Displaying such information may not only benefit the photography company but may also benefit the student, student's guardian or other persons by supplying helpful information. The back side of upper portion 102 of form 100 may also comprise ordering, personal, or payment information that is sent to the photography company when photographs or other merchandise are purchased. Additionally, the back side of middle portion 104 of form 100 may also comprise ordering, personal, or payment information that is retained by the student and/or the student's guardian for future reference and future purchase orders.

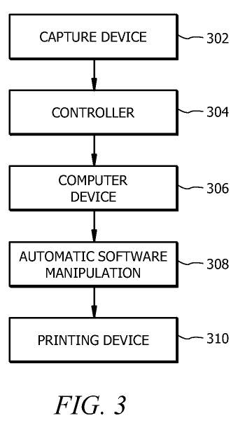

FIG. 3 depicts an embodiment of the present invention comprising a system and method for capturing an image and automatically printing the captured image to the form 100 of FIGS. 1 and 2. For example, a photographer can capture an image of a student during a photo shoot and automatically print out the prefatory photograph to the prefatory photograph areas 112, 116 on form 100 without manually manipulating or modifying the prefatory photograph's size, shape, or placement. At the moment of capture, a digital image of the capture is transmitted to a printer whereupon the printer prints the prefatory photograph onto form 100. This process is quick and efficient, requiring only seconds until the form 100 comprises one or more of the requisite elements, to wit, at least one prefatory photograph, at least one identification code, at least one ordering instruction template, and/or information relating to postal payment such as the Centralized Automatic Processing System.

It should be understand that the form 100 can be pre-printed with any or all of the above information before the photo shoot. For example, form 100 may comprise all of the information aforementioned except prefatory photographs in which case the prefatory photographs would be the only item printed thereon at the photo shoot.

As shown in FIG. 3, a capture device 302 such as but not limited to a non-digital or digital camera is utilized to capture an image. Once the image is capture, it is electronically transferred to a controller 304 or other device to manage, command, direct, or regulate the transfer of the digital image. The controller 304 may be connected to a computer device or may be a stand-alone device.

The controller 304 transfers the digital image to a computer device 306 having a particular software application that is utilized to manipulate the digital image. Automatically and without user input during the photo shoot, the software application manipulates the digital image such that the digital image is duplicated, cropped, and re-positioned to predetermined areas and desired locations on form 100 of FIG. 1, to wit, the prefatory photograph areas 112, 116. Once the software application has automatically manipulated the digital images, the digital image is transferred to a printing device 310 wherein the digital images are printed to form 100 of FIGS. 1 and 2.

Among its many features, the software application allows for the collection, assemblage, arrangement, and aggregation of customer data and other important information concerning a particular photo shoot. This aggregation of information is similar to a database wherein information is efficiently organized and can be quickly retrieved. When Little Jimmy's photograph is taken at a photo shoot, for example, information such as the photo shoot's venue (i.e. North City Public School), the time of the photo shoot (i.e. Sep. 1, 2007), and the person(s) depicted in the photograph (i.e. Jimmy Smith) is inputted into the software application. Such information comprises a job session, however it should be understand that a job session is not limited to a specific aggregation of information. The job session can be associated with the identification code 114, 118, 124 printed on the form 100 for identification and organization purposes.

Additionally, the software application allows for dynamic, real time modifications to the ordering instruction template. Because the ordering instructions may contain pricing in addition to particular purchase options, modification may be necessary. For example, a photography company may choose to sell high school photographs at a higher price than elementary school photographs. As such, the software application can allow dynamic, real time modifications to an ordering instruction template before or during a particular job session at a photo shoot.

The software application also allows the photographer to print large photograph images (i.e. photographer's proofs) during a photo shoot. Schoolteachers and/or the photographer can use the photographer's proofs for identification purposes.

In addition, the software application allows for multiple copies of a photograph to be associated with different job sessions. For example, a group photograph of a school soccer team will comprise the same photograph but different multiple job sessions due to the many players that comprise the soccer team. As such, several copies of form 100 will be printed having identical prefatory photographs and ordering instruction templates but a different identification code associated with differing job sessions. Thus after one group photo shoot, several differing forms 100 are quickly generated, printed, and provided to each member of the group.

Similar to the method and system depicted in FIG. 3, another embodiment envisions the incorporation of the controller 304, computer device 306, and automatic software manipulation 308 into either the capture device 302 or the printing device 310. As such, the capture device would capture the image, manipulate the image, and transfer the digital representation of the manipulated image to the printer 310 for printing to form 100. In a separate embodiment, the capture device 302 would capture the image and transfer the captured image to a printer 310 wherein the printer 310 would manipulate the digital representation of the image. Then the printer 310 would print the manipulated image to form 100.

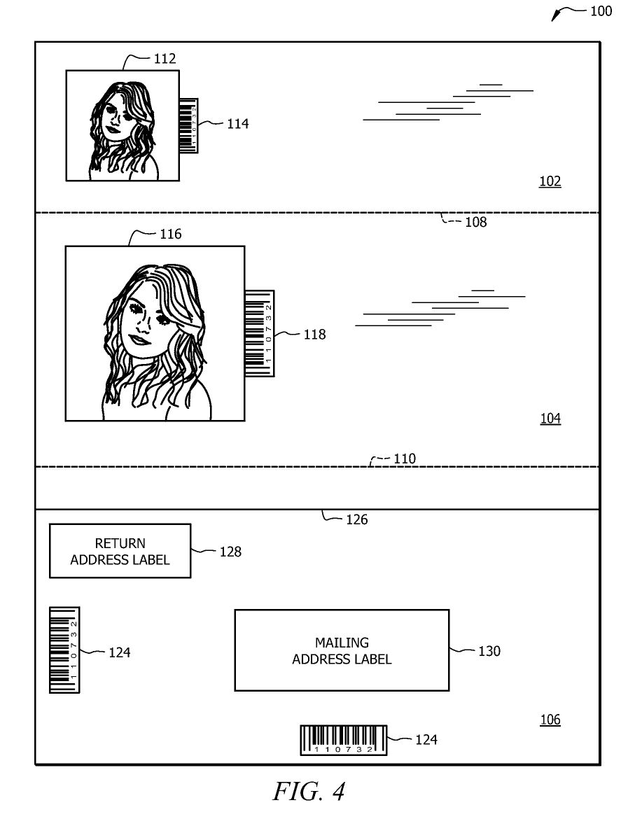

FIG. 4 illustrates form 100 after the printing device 310 has printed the digital images thereto. One, two or more of the same prefatory photographs are printed at prefatory photograph areas 112, 116.

After the prefatory photographs are printed to form 100, form 100 is given to the student and/or the student's guardian moments after the photo shoot. The student and/or the student's guardian assents and consents to the purchase of photograph(s) and/or other merchandise by marking the appropriate fields and supplying personal information such as a name and credit card information in the upper portion 102 of form 100.

The upper portion 102 is separated from the middle portion 104 via the perforated line 108; the middle portion is separated from the lower portion 106 via the perforated line 110. Then, the upper portion 102 is inserted into the envelope 120 of the lower portion 106. Upon insertion, the upper portion 102 is sealed into the envelope 120 when the adhesive section 122 is moistened and folded at the creased line 126 until the contents of envelope 120 is enclosed and sealed. However as previously disclosed herein, other embodiments are envisioned wherein the upper portion 102 and middle portion 104 are interchangeable such that the middle portion 104 may be separated from form 100 and inserted into envelope 120 for delivery to the photography company and the upper portion 102 may be retained by the student and/or the student's guardian for future reference or for future purchase(s) of merchandise.

The student and/or the student's guardian supplies the return address 128 on the envelope 120. Then, the envelope is placed in the mail whereupon it is subsequently received and processed by the photography company. The photography company utilizes the unique identification code 124, 114 to associate the purchase order with the student and/or the student's guardian.

The student and/or the student's guardian retains possession of the middle portion 104. Since unique identification codes 114, 118, 124 are affixed to the envelope 120, upper portion 102 that is received by the photography company, and the middle portion 104 that is retained by the student and/or the student's guardian, record-keeping is performed more efficiently and effectively.

The embodiments of the present invention applies to forms, regardless of type, function or content, envelopes, regardless of type or function, unique identification codes, regardless of type, function or content, capture devices, regardless of type or function, controllers, regardless of type or function, computer devices, regardless of type or function, software applications, regardless of type or function, printing devices, regardless of type or function, and prefatory photographs, regardless of type, function or content.

Although the embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

What is claimed is:

1. A two-sided, separable photography form for printing a prefatory photograph thereto and for subsequently retaining a prefatory photograph therefrom, the form comprising:
an upper portion, the upper portion comprising a region for printing a prefatory photograph thereto;
a middle portion separably adjoining the upper portion, the middle portion comprising a region for printing a prefatory photograph thereto; and
a lower portion separably adjoining the middle portion, the lower portion comprising an envelope.

2. The two-sided, separable photography form of claim 1 wherein the upper portion is inserted into the envelope after detachment from the form.

3. The two-sided, separable photography form of claim 1 wherein the middle portion is inserted into the envelope after detachment from the form.

4. The two-sided, separable photography form of claim 1 wherein the upper portion comprises a region for printing ordering instructions thereto.

5. The two-sided, separable photography form of claim 4 wherein the upper portion comprises a region for providing personal information thereto.

6. The two-sided, separable photography form of claim 1 wherein the middle portion comprises a region for printing ordering instructions thereto.

7. The two-sided, separable photography form of claim 1 wherein the upper portion comprises a region for printing an identification code thereto that is readable by a computer device.

8. The two-sided, separable photography form of claim 1 wherein the middle portion comprises a region for printing an identification code thereto that is readable by a computer device.

9. The two-sided, separable photography form of claim 1 wherein the lower portion comprises at least one region for printing an identification code thereto that is readable by a computer device.

10. The two-sided, separable photography form of claim 1 wherein a postage payment system of the envelope comprises the United States Postal Services Centralized Account Processing System.

11. A photography system for capturing and printing a prefatory photograph to a two-sided, separable photography form, the system comprising:
a capture device for capturing a prefatory photograph and manipulating the digital representation of the prefatory photograph; and
a printing device interfacing the capture device wherein the printing device prints at least one prefatory photograph, at least one ordering instruction template, at least one identification code readable by a computer device, and postage payment information to the two-sided, separable photography form.

12. The photography system of claim 11 further comprising a controller wherein the controller manages the transfer of a digital representation of a prefatory photograph captured by the capture device.

13. The photography system of claim 11 further comprising a computer device wherein the computer devices includes a software application that automatically manipulates a digital representation of at least one prefatory photograph captured by the capture device, at least one ordering instruction template, at least one identification code, and postage payment information.

14. A photography method comprising:
capturing a prefatory photograph with a capture device;
manipulating a digital representation of the prefatory photograph captured by the capture device;
manipulating a digital representation of an ordering information template;
manipulating a digital representation of at least one identification code wherein the identification code is readable by a computer device;
manipulating postage payment information; and
printing at least one prefatory photograph, at least one ordering instruction template, at least one identification code, and postage payment information to a two-sided, separable photography form wherein the two-sided, separable photography form comprises three adjoining portions and wherein one portion of the form comprises an envelope.

15. The photography method of claim 14 further comprising creating a job session to efficiently organize photo shoots, student photographs, student data, and ordering instruction templates.

16. The photography method of claim 15 wherein the ordering instruction template can be linked to a job session.

17. The photography method of claim 14 further comprising printing a photography proof for purposes of identification.

18. The photography method of claim 14 wherein printing at least one prefatory photograph, at least one ordering instruction template, at least one identification code, and postage payment information to a two-sided, separable photography form is performed during a photo shoot.

19. The photography method of claim 14 further comprising printing multiple copies of a two-sided, separable photography form wherein each copy of the form comprises at least one identical prefatory photograph and at least one identical ordering instruction template.

20. The photography method of claim 19 wherein each copy of the form comprises at least one different identification code that is readable by a computer device.
